(19) United States
(12) Patent Application Publication
(10) Pub. No.: US 2001/0026262 A1
(43) Pub. Date: Oct. 4, 2001

(54) Apparatus and system for reproduction of handwritten input

(76) Inventors: Henricus Antonius Wilhelmus Van Gestel, Eindhoven (NL); Nathalie Dorothee Pieternel Leurs, Eindhoven (NL)

Correspondence Address: Jack E. Haken, c/o U.S. PHILIPS CORPORATION, Intellectual Property Department, 580 White Plains Road, Tarrytown, NY, 10591, US

(21) Appl. No.: 09/738,647

(22) Filed: Dec. 15, 2000

(30) Foreign Application Priority Data
Dec. 17, 1999 (EP) 99204372.9

(51) Int. Cl. G09G 5/00

(52) U.S. Cl. 345/156

(57) ABSTRACT

An apparatus (100) has an input device (102) for inputting a handwritten message. The apparatus has a recognition unit (106) for recognizing individual handwritten characters in the message. Furthermore, the apparatus has a selection unit (108) for selecting a font on the basis of the handwritten characters. This message is displayed on a display device (104) in the selected font to give the displayed message a style reflecting the personal characteristics of the user's handwriting.

The invention relates to an apparatus for reproducing handwritten input, comprising: an input device for inputting one or more handwritten characters, a recognition unit for recognizing the one or more handwritten characters, a selection unit for selecting a font, and a display unit for on a display device in the selected font displaying one or more display characters corresponding to respective ones of the recognized handwritten characters.

The invention further relates to a system for transmission of handwritten input comprising: a transmitter having an input device for inputting one or more handwritten characters, a recognition unit for recognizing the one or more handwritten characters and representing them as one or more respective character codes, a selection unit for selecting a font, and transmission means for transmitting the one or more characters codes and a font identification of the selected font to a transmission medium; and a receiver having receiving means for receiving the one or more character codes and the font identification from the transmission medium and a display unit for on a display device in the selected font displaying one or more display characters corresponding to respective ones of the character codes.

The invention further relates to a transmitter for use in a system for transmission of handwritten input, the transmitter comprising an input device for inputting one or more handwritten characters, a recognition unit for recognizing the one or more handwritten characters and representing them as one or more respective character codes, a selection unit for selecting a font, and transmission means for transmitting the one or more characters codes and a font identification of the selected font to a transmission medium.

The invention further relates to a method of reproducing handwritten input, comprising the steps of: inputting one or more handwritten characters, recognizing the one or more handwritten characters, selecting a font, and in the selected font displaying one or more display characters corresponding to respective ones of the recognized handwritten characters.

The invention further relates to a computer program for carrying out this method and a tangible medium carrying such a program.

U.S. Pat. No. 5,502,461 describes an apparatus that recognizes handwritten characters and reproduces these characters. The apparatus has an input device which is suitable both for input and for output. A user writes input on the input device and the apparatus displays certain information on the input device. The input device consists of a coordinate input tablet and an LCD device integrated into one single device. The apparatus displays one or more character input boxes on the input device and the user writes a character in such a box. The user may adjust the size of the character input boxes. After recognition, the handwritten input is erased and the recognized character is displayed in that box in a given, uniform font. The font in which the character is displayed is selected in dependence on the size of the character input box. If the user chooses for a large character input box, the apparatus displays the handwritten input by means of large characters and if the user chooses for a small character input box, the apparatus displays the handwritten input by means of small characters.

It is an object of the invention to provide an apparatus as described in the preamble with an improved reproduction of the handwritten input. This object is achieved according to the invention in an apparatus that is characterized in that the selection unit is arranged to select the font on the basis of the one or more handwritten characters. The recognition of the inputted characters and the subsequent representation of the message as standard characters make it possible to electronically process the message in the same way as a message entered by keyboard, e.g. the message can be edited with a word processor. Selecting the font on the basis of the handwritten characters themselves makes it possible to display the handwritten input in a font that resembles the user's handwriting. In this way, a handwritten message can be displayed in a personal style reflecting the author's own handwriting and can still be electronically processed. The apparatus according to the invention improves the readability of the handwritten message provided by the user while preserving to a certain extent the personal style of the message.

An embodiment of the method according to the invention is described in claim 2. By creating a new font on the basis of the handwriting of the user, the handwritten message can be reproduced in a way that stronger resembles the original writing, while still keeping the advantage of electronic processing.

An embodiment of the method according to the invention is described in claim 3. This is a simple way to create a font on the basis of the handwritten characters.

It is a further object of the invention to provide a system as described in the preamble with an improved reproduction of the handwritten input. This object is achieved according to the invention in a system that is characterized in that the selection unit is arranged to select the font on the basis of the one or more handwritten characters. The handwritten message may be reproduced at the receiver's side in a way that still reflects the personal handwriting of the author at the transmitting side, while the processing and transmission is done on the basis of character codes. This gives a more attractive display of a given message than if all messages were displayed in a single, standard font.

It is a further object of the invention to provide a transmitter as described in the preamble which allows an improved reproduction of the handwritten input. This object is achieved according to the invention in a transmitter that is characterized in that the selection unit is arranged to select the font on the basis of the one or more handwritten characters.

It is a further object of the invention to provide a method as described in the preamble with an improved reproduction of the handwritten input. This object is achieved according to the invention in a method that is characterized in that the font is selected on the basis of the one or more handwritten characters.

An embodiment of the method according to the invention is described in claim 8. By basing the selection of the font on a number of recognized characters, the selection can be done better and more reliably. An irregularity in a given character will then not easily lead to the selection of an inappropriate font. Furthermore, when a new font is created, it is also advantageous to use a number of handwritten characters for this purpose.

The invention and its attendant advantages will be further elucidated with the aid of exemplary embodiments and the accompanying schematic drawing, wherein:

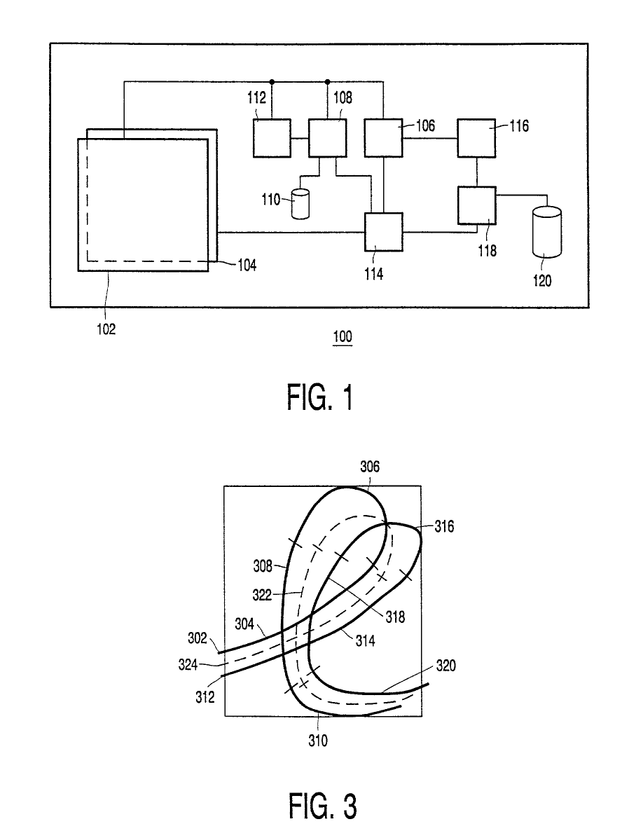

FIG. 1 schematically shows an apparatus according to the invention,

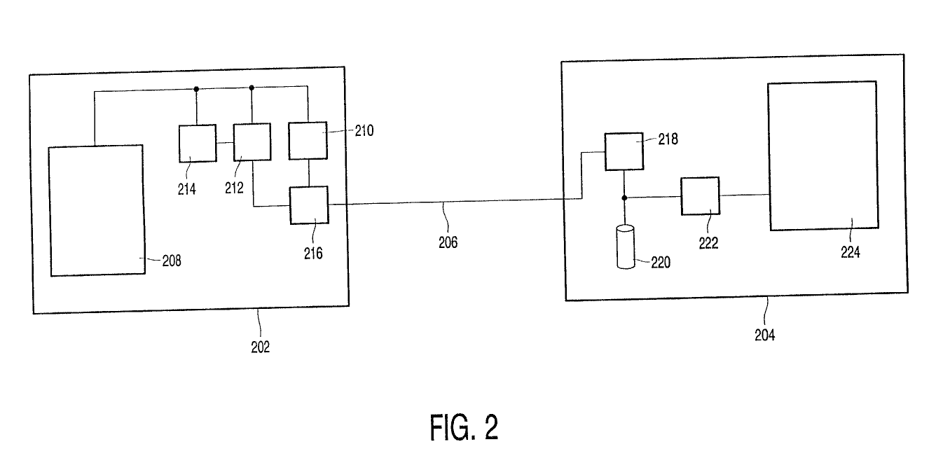

FIG. 2 schematically shows a system according to the invention,

FIG. 3 shows a first example of the creation of a new font,

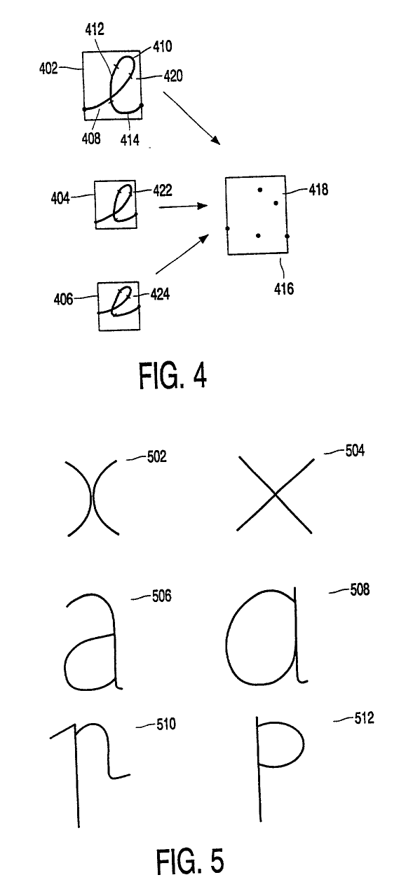

FIG. 4 shows a second example of the creation of a new font, and

FIG. 5 shows some characters for characterizing a font.

Corresponding features in the various Figures are denoted by the same reference symbols.

FIG. 1 schematically shows an apparatus according to the invention. The apparatus 100 has an input device 102 for the entry of handwriting. This input device is operated by means of a pen and the location of the pen on the surface of the device is detected. In this way, movements of the pen for inputting strokes of a character are detected by the input device. The apparatus has a display device 104 which is integrated with the input device. This display device initially shows the positions where the pen has touched the input device, thus imitating the writing with an ink pen on paper. So the user sees the input appearing on the input device. After recognition, the display device 104 shows the recognized character. A recognition unit 106 analyzes the input written on the input device and tries to recognize a character in the input. A selection unit 108 selects a font on the basis of the handwritten input character. In a simple embodiment, the font is selected from a number of predefined fonts available in font storage 110. Examples of predefined fonts that are suitable to represent handwritten input are Casual, Hyena and Comic sans MS. In order to make a selection among the available fonts, a characterizing character in the handwritten font is compared with the corresponding characters in the respective fonts. FIG. 5 shows some examples of such characterizing characters.

In a more advanced embodiment, the apparatus has a creation unit 112 to create a new font on the basis of the handwritten input. Ways of creating a new font are given below in connection with FIG. 3 and 4. After a character has been recognized and an appropriate font has been selected, a display unit 114 generates a display character for display on display device 104. The original handwritten character is removed from the display and is replaced by the display character. Alternatively, it is possible to display the display character at another position on the display device and retain the display of the original handwritten character as well. It is also possible to display the display character on a different display device which is not part of the apparatus itself.

Optionally, the apparatus is equipped with a segmentation unit 116 which identifies individual words in the handwritten input message and a spell check unit 118 to check the spelling of the identified words. The spell check unit verifies whether any such word is present in an electronic dictionary 120.

The activation of selection unit 108 for selecting a font may be postponed until a number of characters have been recognized in the handwritten input. In this way, the selection of the font is carried out on the basis of a number of characters and will result in a better selection. Otherwise, the irregularity of a single handwritten character may result in the selection of a further inappropriate font. By the same token, the activation of creation unit 112 for creating a new font may be postponed. Furthermore, it is possible to await a special command given by the user. In that case, the apparatus only displays the handwritten input as given by the user until the user gives this special command. After this command has been given, the apparatus displays the handwritten message in an appropriate font. The message in this font may replace the original handwritten message or may be displayed in addition to that. The special command is called the ‘embellish command’ since it embellishes the message provided so far. The user issues this command by selecting the appropriate button from a menu of buttons provided on the input device. Alternatively, the apparatus may have a push button for this purpose.

An alternative for inputting the handwriting using the input device described above is to write the input on a paper and to use a scanner to obtain an image from the input. The recognition unit then uses that image as input instead of the output of the input panel. Further alternatives for inputting the handwritten characters are possible, like a camera viewing real time writing on a board.

In an embodiment of the apparatus according to the invention, there may be an additional source for entering the message that is to be displayed. This additional source may be a keyboard for entering a number of characters. The characters from this additional source are still displayed in the selected font. This means that although part of the message is entered via a keyboard, the whole message is displayed in the font selected on the basis of the handwriting of the user. Furthermore, the selected and possibly newly created font for a given message may be stored and used for later messages as well. In that way, a later message may be fully typed in via the keyboard but displayed in a font resembling the user's handwriting. The apparatus according to the invention may verify over time, whether the stored font still resembles the user's handwriting sufficiently. If a significant difference is established, the apparatus may adapt the stored font to the changed handwriting.

FIG. 2 schematically shows a system according to the invention. The system 200 includes a transmitter 202 for entry and transmission of a handwritten message and a receiver 204 receiving and displaying this message. The transmitter 202 transmits the entered message to the receiver 204 via a transmission medium 206. This may be a network connection like the Internet, a broadcast of the message via a radio frequency or some other suitable medium. The transmission medium is shown as a direct connection, but may include one or more intermediate servers where the message is temporarily stored.

The transmitter 202 has an input device 208 for the entry of handwriting. This input device is similar to the input device described above and is capable of directly displaying the input and may be capable of displaying recognized characters. A recognition unit 210 analyzes the input written on the input device and tries to recognize a character in the input. A recognized character is further represented by character code identifying that character. A selection unit 212 selects a font on the basis of the handwritten input character. In a simple embodiment, the font is selected from a number of predefined fonts. In a more advanced embodiment, the apparatus has a creation unit 214 to create a new font on the basis of the handwritten input. The transmitter further has transmission means 216 to transmit the character codes representing the inputted message and an identification of the selected font to the transmission medium 206.

In the embodiment comprising the creation unit for a new font, the transmission is also arranged to transmit the newly created font to the transmission medium. The new font need to be sent only once to a specific receiver after which the display of the message on that receiver can take place in the desired font. To this end, the transmitter may keep a record of receivers to which the new font has been transmitted and in this way may avoid transmitting the font again for a message that is to be displayed in that same font.

The receiver 204 has receiving means 218 for receiving the message in the form of character codes from the transmission medium and for receiving the identification of the font in which the message is to be displayed. In the embodiment of the system where a new font is created and sent by the transmitter, the receiving means 218 is further arranged to receive this new font and to store it in font storage 220. The receiver further has a display unit 222 for displaying display characters corresponding to the received character codes of the message on a display device 224. The display characters are in the font according to the received font identification. The display device 224 may be integrated with the receiver, as shown in FIG. 2, or may be a separate device to which the receiver sends the display signals.

An embodiment of the system according to FIG. 2 is sending of a handwritten message as e-mail from a PDA (Personal Digital Assistant) having a touch sensitive screen as input device. The PDA recognizes the handwritten message and transforms this in an e-mail with the appropriate font. This e-mail is sent to the Internet server, addressed to the intended recipient or recipients. The recipient receives the e-mail from his Internet server to his local computer, which may also be a PDA or a Personal Computer or other suitable workstation, where it is displayed in the intended, personal font of the sender of the e-mail.

In an embodiment of the system according to the invention, there may be an additional source for entering the message that is to be displayed. This additional source may be a keyboard for entering a number of characters. The characters from this additional source are still displayed in the selected font. This means that although part of the message is entered via a keyboard, the whole message is displayed in the font selected on the basis of the handwriting of the user. Furthermore, the selected and possibly newly created font for a given message may be stored and used for later messages as well. In that way, a later message may be fully typed in via the keyboard but displayed in a font resembling the user's handwriting. The system according to the invention may verify over time, whether the stored font still resembles the user's handwriting sufficiently. If a significant difference is established, the system may adapt the stored font to the changed handwriting.

FIG. 3 shows a first example of the creation of a new font. First, from available fonts a font is selected that best resembles the handwritten characters. Then for a given letter of the alphabet, a handwritten character is compared with the corresponding character of the font and a new character is created that is an average between the two. This process is repeated for every letter of the alphabet, whenever one or more occurrences of that letter appear in the handwritten message. Character 302 is from the selected font and consists of strokes 304, 306, 308 and 310. Character 312 is the corresponding handwritten character and is decomposed in similar strokes 314, 316, 318 and 320. Each stroke of the font character is paired with the corresponding stroke of the handwritten character, e.g. stroke 308 with stroke 318, and a new stroke 322 is created that is an average between the two. This average stroke is determined by minimizing the square distance between this new stroke and both other strokes. The character 324 for the new font is now composed of the new strokes generated for each pair of strokes.

FIG. 4 shows a second example of the creation of a new font. In this case the new font character for a letter of the alphabet is generated on the basis of one or more occurrences of that letter in the handwritten text. The new font character is created as an average of the corresponding handwritten characters. Characters 402, 404 and 406 are handwritten characters from handwritten text. Each of those characters is decomposed into a number of strokes. For example, character 402 is decomposed into strokes 408, 410, 412 and 414. The new character 416 is generated on the basis of the average of the respective strokes of the handwritten characters. As a first step, the connection points between the strokes of the new character are determined. Such a connection point in the new character is calculated on the basis of the corresponding connection points of the handwritten characters. For example, point 418 is the average of point 420, 422 and 424. Then each stroke of the new character is determined on the basis of the corresponding strokes of the handwritten characters. The new stroke is made to correspond as much as possible to the original strokes by minimizing the square distance between the new stroke and each of the original strokes.

In general, the new font is created to meet two criteria with respect to the handwritten input. On the one hand, the variations in the various occurrences of the handwritten characters are removed in order to give the text a regular and orderly appearance. On the other hand, the characteristics of the handwritten characters compared with the existing fonts are retained in the new font in order to give the new font the personal style of the writer.

Handwritten characters may have one or more lines with a primary orientation with respect to the (virtual) line on which they are written. These lines are the main elements when writing such characters and are called ‘ascenders’ or ‘descenders’ depending on the direction during writing. One of the possible steps to come to the new font is to align the ‘ascenders’ and ‘descenders’ of the various different handwritten characters. Or in other words, the characters are given the same skew in order to give the written text a more regular appearance.

Handwritten characters may have fully closed areas, also called ‘eyes’. One of the possible steps to come to the new font is to make the ‘eyes’ for corresponding characters the same size. For instance the eye of the character ‘p’ is given the same size as that of the character‘q’.

FIG. 5 shows some characters for characterizing a font. The appearance of such a character in one font is very different from its appearance in another font. This makes such a character suitable to use for selecting a font. When such a character is recognized in the handwritten input, the selection means may select that font from the available fonts in which the appearance of the character resembles most the handwritten character. Character 502 shows the appearance of the letter ‘x’ in one font and character 504 shows the appearance of the letter ‘x’ in another font. Similarly, characters 506 and 508 show two appearances of the letter ‘a’ in respective fonts and characters 510 and 512 of the letter ‘p’.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the device claim enumerating several means, several of these means can be embodied by one and the same item of hardware.

What is claimed is:

1. Apparatus for reproducing handwritten input, comprising: an input device for inputting one or more handwritten characters, a recognition unit for recognizing the one or more handwritten characters, a selection unit for selecting a font, and a display unit for on a display device in the selected font displaying one or more display characters corresponding to respective ones of the recognized handwritten characters, characterized in that the selection unit is arranged to select the font on the basis of the one or more handwritten characters.

2. Apparatus as claimed in claim 1 further comprising a creation unit for creating a new font on the basis of the one or more handwritten characters, wherein the selection unit is arranged to select the new font as the selected font in which the one or more display characters are displayed.

3. Apparatus as claimed in claim 2, wherein the creation unit is arranged to create the font on basis of averaging over a number of handwritten characters and on the basis characteristics in this number of handwritten characters.

4. Apparatus as claimed in claim 1, comprising a segmentation unit for segmenting the inputted handwritten characters into one or more words and a spell check unit for verifying the presence of the one or more words in an electronic dictionary.

5. Apparatus as claimed in claim 1, comprising a further input device for inputting further characters, wherein the display unit is arranged for on the display device in the selected font displaying one or more display characters corresponding to respective ones of the further characters.

6. System for transmission of handwritten input comprising:
a transmitter having an input device for inputting one or more handwritten characters, a recognition unit for recognizing the one or more handwritten characters and representing them as one or more respective character codes, a selection unit for selecting a font, and transmission means for transmitting the one or more characters codes and a font identification of the selected font to a transmission medium; and
a receiver having receiving means for receiving the one or more character codes and the font identification from the transmission medium and a display unit for on a display device in the selected font displaying one or more display characters corresponding to respective ones of the character codes;
characterized in that the selection unit is arranged to select the font on the basis of the one or more handwritten characters.

7. System as claimed in claim 6, wherein the transmitter further comprises a creation unit for creating a new font on the basis of the one or more handwritten characters, wherein the selection unit is arranged to select the new font as the selected font for display, wherein the transmitting means is arranged to transmit the new font to the transmission medium, and wherein the receiving means is arranged to receive the new font from the transmission medium.

8. Transmitter for use in a system for transmission of handwritten input, the transmitter comprising an input device for inputting one or more handwritten characters, a recognition unit for recognizing the one or more handwritten characters and representing them as one or more respective character codes, a selection unit for selecting a font, and transmission means for transmitting the one or more characters codes and a font identification of the selected font to a transmission medium, characterized in that the selection unit is arranged to select the font on the basis of the one or more handwritten characters.

9. Method of reproducing handwritten input, comprising the steps of:
inputting one or more handwritten characters,
recognizing the one or more handwritten characters,
selecting a font, and
in the selected font displaying one or more display characters corresponding to respective ones of the recognized handwritten characters,
characterized in that the font is selected on the basis of the one or more handwritten characters.

10. Method as claimed in claim 9, wherein the font is selected when a predetermined number of characters have been recognized.

11. Computer program for carrying out the steps of the method according to claim 9 or 10.

12. Tangible medium carrying the computer program of claim 11.
